(19) United States
(12) Patent Application Publication
(10) Pub. No.: US 2026/0238583 A1
(43) Pub. Date: Aug. 13, 2026

(54) IMPLEMENTATION OF NETWORK DIAGNOSTICS IN ASSOCIATION WITH A NETWORK MANAGEMENT SYSTEM

(71) Applicant: Arista Networks, Inc., Santa Clara, CA (US)

(72) Inventor: Neha Goyal, Santa Clara, CA (US)

(21) Appl. No.: 19/050,839

(22) Filed: Feb. 11, 2025

(51) Int. Cl. H04L 43/10

(52) U.S. Cl. CPC H04L 43/10

(57) ABSTRACT

Methods and systems for providing central network management systems with the ability to perform network diagnostic commands between devices (or other resources) in a network, receive data associated with the execution of those network commands from the network devices involved with the execution of those network diagnostic commands, and determine and present network diagnostic data associated with the execution of those commands based on that received data, are disclosed herein.

### BACKGROUND

Communications networks such as packet-based networks include network infrastructure devices (also referred to as network nodes) such as network switches or other network devices that implement the network. The network infrastructure devices are used in forwarding or routing network traffic or network flows, such as in the form of packets, between themselves or end hosts (e.g., from packet sources to packet destinations).

In order to allow a user to efficiently operate and identify any issues or inefficiencies in such a network, it is crucial to gather meaningful information regarding the timings associated with packets travelling through the network, or the paths taken by packets for network flows traversing these network nodes. This information can help the user understand the operating parameters of the network such as the network topology, routing algorithms, etc., and troubleshoot network issues such as routing inefficiencies, packet congestion, packet delays, packet losses, etc.

However, it may be difficult to generate proper information to efficiently identify and characterize network issues (e.g., identify if congestion is occurring, determine at which network node(s) the issues such as congestion, delays, or losses are occurring). This is particularly the case in modern network environments where much network management is accomplished using a centralized network management system, which may be cloud based or otherwise implemented remotely from the network infrastructure nodes implementing the network. This is because it is often difficult to perform network diagnostics on individual network infrastructure devices from a central network management system, especially lower level network diagnostics such as those usually available from command line interfaces or tools on the network infrastructure devices themselves.

It is thus desirable to provide all levels of visibility into the operation of network devices at central network management systems, including the ability to initiate the execution of network diagnostic commands on individual network devices from these central network management systems, and to present and evaluate data resulting from the execution of such network diagnostic commands at such central network management systems.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIGS. 1 and 2 (comprising FIGS. 2A and 2B) are block diagrams illustrating networks including embodiments of a central network management system and network devices adapted to cooperate to provide for the execution of network diagnostic command.

FIGS. 3-5 are examples of interfaces that may be employed by embodiments of a central network management system adapted to provide for the execution of network diagnostic commands.

### DETAILED DESCRIPTION

As discussed, communications networks comprise network infrastructure devices that implement the network. The network infrastructure devices are routing or forwarding network traffic or network flows (referred to herein interchangeably as packets without loss of generality) between themselves or end hosts (e.g., from packet sources to packet destinations). In order to allow a user to identify issues or inefficiencies in a network, it is crucial to be able to gather meaningful information regarding the timings associated with packets travelling through the network or the paths taken by packets when traversing the network devices. This information can help the user understand the operation of the network such as the network topology, routing algorithms, etc., and troubleshoot network issues such as routing inefficiencies, packet congestion, packet delays, packet losses, etc.

However, it may be difficult to obtain proper information to efficiently identify and characterize network issues (e.g., identify if congestion is occurring, determine at which network node(s) the issues such as congestion, delays, or losses are occurring). This is particularly the case in modern network environments where much network management is accomplished using a centralized network management system, which may be cloud based or otherwise implemented remotely from the network infrastructure nodes implementing the network.

In particular, in many cases, network diagnostic commands may be utilized to identify issues or inefficiencies in such a network. Two common examples of such network diagnostic commands are the ping and traceroute commands. The ping command is used to test the reachability of a host on a network. The ping command works by sending a small packet of data (e.g. an Internet Control Message Protocol (ICMP) Echo Request) to a target device and then waiting for a response (an ICMP Echo Reply). If the target device is reachable and responds, a message showing the round-trip time (RTT) of the packet in milliseconds will be returned. A ping command can thus be used to determine if a network device is online and reachable. Moreover, by observing the RTT, latency between the source and destination can be assessed. If some or all of the ping requests do not receive a reply, it may indicate packet loss, which can be a sign of congestion or an issue with a network link.

Similarly, a traceroute command may be used to track the path that packets take from a source to a destination. This command shows the sequence of hops (routers or other network infrastructure devices) that a packet passes through. Traceroute can also measure a RTT to each hop of a path, which assists in pinpointing where delays or packet losses occur in the path. The traceroute command operates by sending out a series of ICMP Echo Request (or UDP) packets with progressively increasing Time-to-Live (TTL) values. This TTL determines how many hops the packet is allowed to take before being discarded. By starting with a TTL of 1, the packet reaches the first router, which decrements the TTL by 1 and returns an ICMP "Time Exceeded" message. Then, the TTL is increased, and the process is repeated for each hop along the way until the destination is reached. Each network device along the path sends a reply, and the traceroute records the RTT for each hop.

The use of a traceroute command can thus help identify each hop between the issuer of the command (e.g., a source network device) and the destination (e.g., a destination network device) and may be especially useful when diagnosing where a problem occurs in a complex multi-hop network. For example, a traceroute can help determine if packets are being misrouted or if there is a loop in the network. Moreover, by looking at the RTT for each hop returned by a traceroute, network infrastructure devices that are introducing delays may be pinpointed.

The use of these network diagnostic commands, however, typically requires that they be issued from a command line interface (CLI) of the (e.g., source) network infrastructure device from which a user wishes to initiate the network diagnostic command (e.g., if a user wishes to trace a route between a first network device and a second device, the user must access the CLI of the first network device and issue a traceroute command from the CLI of this first network device). This is inconvenient.

Specifically, recent trends have been to migrate network management to central network management systems, and users have grown acclimatized to such convenience. Users thus desire to perform all network management, including in-depth troubleshooting, from such central network management systems. Today’s network deployments are, however, vast, with hundreds (or more) of devices deployed across the network. As these networks are growing, so are the network problems associated with these networks.

Pinpointing where a network issue has occurred is difficult. While these centralized network management systems may give some information regarding issues in these complex networks, in most cases to determine where exactly the problem lies, users eventually rely on rudimentary and low level tools like ping and traceroute, which are usually only available from the CLI of a network device itself. Having to manually log into, or otherwise, access (what may be multiple) individual network devices to execute (what may be multiple) network diagnostic commands while troubleshooting a network, and to manually correlate and evaluate the data that is returned from these commands, is problematic for most users.

It is thus desirable to provide all levels of visibility into the operation of network devices at central network management systems, including the ability to initiate the execution of network diagnostic commands between individual network devices or other resources and to present and evaluate data resulting from the execution of such network diagnostic commands at these central network management systems. The execution of network diagnostic commands between network devices from central management platforms, and the presentation of associated data is, however, not straightforward. More specifically, while such network diagnostic commands may be initiated remotely, the data returned from these commands is not usually available through such remote connectivity. Additionally, the data associated with the execution of these diagnostic commands related to other network devices involved in the execution of that network diagnostic command or data associated with the execution of these network devices between network devices or other resources is almost never available.

Accordingly, what is desired are methods and systems to equip central network management systems with the ability to perform network diagnostic commands like ping and traceroute or other functionality (e.g., that involve passing data between multiple network devices), which are traditionally offered from CLIs of network devices. Moreover, it is desirable to obtain data from network devices on the network involved with the execution of such network diagnostic commands (e.g., not just the device on which a command was initiated). By doing so, users’ (e.g., a network administrator or the like) ability to network troubleshoot using these central network management systems is facilitated, reducing or eliminating the reliance on CLIs for network management and diagnostics.

Moreover, additional data may be provided (e.g., at the central network management system) from the execution of these network diagnostic commands by collecting data returned from network infrastructure devices involved with the performance of such network diagnostic commands, not just the source (or destination) involved with the execution of those commands or the device on which the command was initiated. This capability (e.g., the ability to obtain data on commands from devices other than the source device or the device on which the command was initiated) allows the identification of specific data such as whether multiple paths are available, what those paths are and the health of such paths in a network.

Additionally, central network management systems may have a plethora of data available regarding the network, such as network topology data or the like, along with the ability to present such data in a variety of manners. Accordingly, mappings of the paths taken by such packets or other network diagnostic data determined from performance of these network diagnostic commands may be correlated with this network topology data and presented to a user from the central network management system according to a desired method of presentation. For example, one or more paths taken by the packets involved in the execution of network diagnostic commands may be determined at the central network management system, may be mapped to network topology data available to the central network management system, and a visual presentation of one or more paths in the network taken by these packets presented to a user by the central network management system.

Embodiments as disclosed herein may thus provide systems and methods for implementing network diagnostic commands in association with a centralized network management system. In particular, embodiments may provide an interface at a central management system that allows a user to specify a network diagnostic command (e.g., a ping or a traceroute, or other functionality or tools available on a network device) and a source and or destination in a network (e.g., Internet Protocol (IP) address or other identifier associated with a source network device or destination network device) for that network diagnostic command.

Based on the specified diagnostic command and the associated source or destination, the central network management system can access the source network device associated with the network diagnostic command, such as through an embedded Application Programming Interface (eAPI) offered by an operating system of the network device or a secure shell (SSH), to execute the network diagnostic command specifying the source and the destination. In certain embodiments, the central network management system may access the source network device and execute the network diagnostic command using a network diagnostic agent on the source device (e.g., using a Remote Procedure Call (RPC) interface such as gRPC). These network diagnostic agents may be included on one or more network infrastructure devices along with a network telemetry agent. The network telemetry agent may be adapted to provide data (e.g., network diagnostic data such as packet data or the like) to a central network management system.

The central network management system can thus access the network diagnostic agent on the source device to execute a network diagnostic command such as a ping or traceroute. The network diagnostic agent can then execute the network diagnostic command using the specified source and destination. In one embodiment, a network device may be adapted to create a mirror session (e.g., the operating system or an agent of the network device may be adapted to create a mirror session), and in particular may be adapted to create a mirror session from the data plane of the network device to the control plane of the network device.

Accordingly, when the execution of a network diagnostic command at the network device (e.g. a ping or a traceroute command) is initiated by a central network management system, the network diagnostic agent may establish a mirrored session for the session used to execute the network diagnostic command at the network device. Thus, data associated with the execution of that network diagnostic command may be mirrored to the control plane of that source network device and, more specifically, mirrored such that the data is provided to the network diagnostic agent at the source network device of the network diagnostic command. As this network diagnostic data (e.g., network diagnostic packets such as ICMP packets or results of the execution of the network diagnostic command) are received by the network diagnostic agent through the mirrored session, associated network diagnostic data may be provided to the central network management system through the network telemetry agent at the network device.

In one embodiment, in order to enable the provisioning of network diagnostic data from network devices to the central network management system, the network diagnostic agent at the source network device may mark a (network diagnostic) packet sent for implementing the network diagnostic command (e.g., the ICMP Echo Request), such as including a particular identifier in the network diagnostic packet. This identifier may be a central network management system initiated identifier, indicating the network diagnostic command with which the network diagnostic packet is associated was initiated from a central network management system (e.g., as opposed to the network diagnostic command being initiated by a user through the CLI of the source network device).

As this marked network diagnostic packet traverses the network each of the network devices with an installed network diagnostic agent may determine that the network diagnostic packet is associated with a network diagnostic command initiated by central network management system and send network diagnostic data (e.g., a copy of the network diagnostic packet or a portion of the network diagnostic packet, or other data etc.) to the central network management system using the network telemetry agent on that network device. Additionally, the response network diagnostic packet (e.g., ICMP Echo Reply) sent from the destination network device may also be marked with the same identifier (e.g., central network management system initiated identifier). As this response network diagnostic packet traverses the network on the path back to the source network device, each of those network devices with an installed network diagnostic agent may likewise determine that this response packet is associated with the network diagnostic command initiated by central network management system and send network diagnostic data (e.g., a copy of the network diagnostic packet or a portion of the network diagnostic packet, or other data etc.) to the central network management system using the network telemetry agent on that network device. Accordingly, as these marked network diagnostic packets traverse the network, each of the network devices with an installed network diagnostic agent may determine that the packet is associated with a network diagnostic command initiated by central network management system and send network diagnostic data (e.g., a copy of the network diagnostic packet or a portion of the network diagnostic packet, etc.) to the central network management system using the network telemetry agent on that network device. Thus, network diagnostic data associated with the execution of network diagnostic commands between network devices or other network devices may be obtained.

Specifically, each network diagnostic agent may be adapted to determine that a marked network diagnostic packet has been received at the network device and provide network diagnostic data on this network diagnostic packet (e.g., a duplicate of the network diagnostic packet, data from the network diagnostic, other network diagnostic data determined by the network diagnostic agent, etc.) to the network telemetry agent present on the network device for sending to the central network management system. Moreover, when the source network device from which the network diagnostic command was initiated receives a network diagnostic packet comprising the response to the network diagnostic command (e.g., an ICMP Echo Reply), network diagnostic data on this network diagnostic response packet (e.g., including the network diagnostic data associated with the initiated network diagnostic command) may be provided to the central network management system using the network telemetry agent present on the source network device.

In some embodiments, to allow network devices along the path of a network diagnostic command route to send associated network diagnostic data to the central network management platform, certain options may be utilized when initiating the network diagnostic command at a source network device. These options may be used, for example, in conjunction with, or alternatively to, marking a network diagnostic packet with an identifier (e.g., indicating a central network management system initiated network diagnostic command). For example, when initiating a ping command a network diagnostic agent at the source network device may initiate the ping command to the specified destination network device using a record route option for the ping command. Not only does the use of such an option cause network devices along the path between the source and the destination (e.g., including the return path) to add their IP address to the network diagnostic packet (e.g., ICMP packet’s) options field, but may additionally cause that network diagnostic packet to be processed in the control plane at each network device.

In these embodiments, the network diagnostic agent may be adapted to detect network diagnostic packets (e.g., ICMP packets) being processed in the control plane of the network device on which it is installed (e.g., or network diagnostic packets being processed in the control plane that also include a particular identifier) and provide network diagnostic data on this network diagnostic packet (e.g., a duplicate of the packet, a portion of the network diagnostic packet, etc.) to the network telemetry agent present on the network device for sending to the central network management system.

In one embodiment, the implementation of the network diagnostic command may be leveraged to allow network devices along the path of a network diagnostic command to send associated network diagnostic data to the central network management platform. To illustrate, a traceroute command works by utilizing the TTL field in IP packets to map a path between a source network device and a destination network device. Specifically, the source network device sends out a set of network packets with increasing values in the TTL field. As each network diagnostic packet traverses the hops along the path to the destination network device, each network device along the path decrements the TTL field. When the TTL value of the network diagnostic packet reaches zero (e.g., after decrementing the TTL value), the network device discards the packet and sends an ICMP "Time Exceeded" message back to the source network device.

Thus, in these embodiments, the network diagnostic agent on each network device in the network may be adapted to determine when a network diagnostic packet has a TTL value of zero after decrementing the value. When it is determined that the network diagnostic packet has a TTL of zero, network diagnostic data on that network diagnostic packet may be provided to the central network management system (e.g., by the network diagnostic agent on the network device using the network telemetry agent on the network device).

While embodiments have been described with respect to certain types of network diagnostic commands available from a CLI, and in particular, network diagnostic commands such as ping and traceroute, embodiments may be utilized to execute other types of commands as network diagnostic commands as data can be obtained on these commands in a similar manner using embodiments of a network diagnostic agent and network telemetry agent on network devices in a network.

To illustrate certain embodiments, in many cases, network devices (or operating systems or other control software thereon) provide commands associated with functionality (e.g., tools or applications) that allow packets to be defined (e.g. using a custom definition for one or more characteristics of a packet) and sent from a network device. Such functionality may be offered in association with the operating system on the network device. For example, the EOS™ network operating system from Arista™ may include tools called Iperf and Ethxmit allowing traffic to be generated from a source to a particular destination network device according to a number of defined characteristics, including sending packets of a specific type, or out a specific port. As another example, the EOS™ network operating system may provide functionality to allow sampled flow tracking. Portions of this sampled flow tracking are referred to as Postcard Based Telemetry (PBT). PBT is a method for collecting network telemetry data that involves the concept of sending "postcards" (e.g., specially configured data packets) from network devices to a central management system.

Packets associated with the use of these various types of functionality may be provided to a central network management system using embodiments of a network diagnostic agent on network devices in a network as disclosed. For example, embodiments may provide an interface at a central management system that allows a user to specify (e.g., identify) this network diagnostic functionality (e.g., Ethxmit, PBT, etc.) and a source and or destination in a network (e.g., Internet Protocol (IP) address or other identifier associated with a source network device or destination network device) along with one or more packet or device characteristics to utilize with the specified functionality (e.g., Ethxmit, PBT, etc.).

Based on the specified diagnostic functionality (e.g., and the associated source or destination and packet or device characteristics), the central network management system (e.g., a network diagnostic module at the central network management system) can access the (e.g., specified) source network device (e.g., the network diagnostic agent on the source device),= to initiate execution of the desired functionality according to the specified packet or device characteristics (e.g., through eAPI or SSH or some other mechanism). In particular, the central network management system can initiate execution of the desired functionality between network devices or other network resources in the network.

The network diagnostic agent on the source network device can then execute the specified functionality at the source network device. Packet data (e.g., postcards) associated with the execution of this functionality (e.g., associated with the execution of this functionality between network devices or other network resources) can then be reported to the central network management system from one or more network devices on the network associated with the execution of this network diagnostic functionality (e.g., between the network devices or other network resources) using the network diagnostic agents and network telemetry agents on those network devices. For example, a mirror session may be created by the network diagnostic agent on the source network device when executing the functionality specified by the central network management system such that data associated with the execution of this diagnostic functionality may be mirrored to the network diagnostic agent at the source device, and the source device can provide this network functionality data to the central network management system. Additionally, one of the characteristics specified for the network diagnostic functionality by the network diagnostic agent at the source device when executing the functionality at the source network device may include an identifier indicating a central network management system initiated network diagnostic command. Accordingly, as these marked network diagnostic packets traverse the network (e.g., between network devices or other network resources) each of the network devices with an installed network diagnostic agent may determine that the packet is associated with the network diagnostic functionality initiated by central network management system and send packet data (e.g., a copy of the packet or a portion of the packet, etc.) to the central network management system using the network telemetry agent on that network device.

As can be seen then, a central network management system can receive network diagnostic data from one or more of the network devices (e.g., the network telemetry agent on each of the network devices) in a variety of manners. Thus, in some embodiments, the central network management system may correlate the received network diagnostic data associated with the network diagnostic command (e.g., as received from different network devices, or the same network device at different times) at the central network management system. According to one embodiment, for example, the network diagnostic data received from each of the network devices may be correlated based on the presence of the same specified source and destination network device (e.g., IP address) in the network diagnostic data (e.g., copy of the network diagnostic packet) received from each of the network devices.

Other data may also be used to correlate or otherwise analyze the network diagnostic data, such as an identifier (e.g., IP address) of the network device or network telemetry agent or network diagnostic agent from which the network diagnostic data was received, a timestamp associated with the network diagnostic data received from the network device, or other data. For example, the central network management system may track network diagnostic commands or functionality instituted by the user at the central network management system and may correlate received network diagnostic data with the network diagnostic commands or other functionality instituted at the central network management system.

Thus, as the central network management system may have network diagnostic data from (e.g., all or a subset of) the hops that the packet took throughout the network, the central network management system may present network diagnostic data on the network diagnostic command initiated at the central network management system to the user who initiated that network diagnostic command, where this network diagnostic data may include data on that network diagnostic command between network devices or other net. This network diagnostic data may include the network diagnostic returned by the network diagnostic command, network diagnostic data resulting from an analysis of the network diagnostic data returned by the network devices used to implement the network diagnostic command, including network diagnostic data on one or more paths between the source or destination (e.g., as determined from the packet data from the network devices), bottlenecks or other impediments to traffic identified through such an analysis, or a visual mapping of the topology of the network associated with implementation of the network diagnostic command (e.g., a visual representation of how the network diagnostic packet traversed the network).

Specifically, as embodiments may allow network diagnostic commands between network devices to be carried out from a central network management system and network diagnostic data associated with those network diagnostic commands to be received at the central network management where it may be analyzed or correlated with other data associated with the network, embodiments may provide an avenue for instituting a number of diagnostic capabilities through a central network management system. As an example of some capabilities that may be provided using embodiments as disclosed using one or more or pings or traceroutes from a central network management systems are discussed below. Other capabilities and uses may be imagined and are fully contemplated herein. In particular, embodiment may be used to provide a ping map at the central network management system, where all pings may be highlighted on a presentation of a topology of a network. Nodes in the network (e.g., network devices) may also be highlighted if a ping was lost at a node in the network. Similarly, a ping mesh may be used to ping from one device to another, from one device to many other network devices, or from many network devices to many other network devices. The results of these ping commands may be displayed on a ping map as discussed. Such a ping mesh capability may be leveraged for various scenarios. For example, to obtain a sampling of network health a random set of devices (e.g., IP address) may be selected in the network and pings issued between or amongst those selected devices using this ping mesh capability.

Embodiments may also be used to set up automatic pings from the central network management system, where those automatic pings may be set up between specified sets of network devices (or set to use randomly selected network devices), and where those automatic pings may be triggered by various network events such as network errors, congestion, higher packet latency, packet loss, link failures, etc. between the affected nodes or from a node to an application, etc. For example a user may establish conditions for such automatic pings through an interface at a central network management system, and be altered when such automatic pings are triggered or alerted to the results of such pings.

The conditions or triggers for instituting these pings can be based on one or more specified conditions (e.g., which the user may specify through the central network management system) such as custom events, or system log or system database events (e.g., a configuration change, etc.) associated with a network device. For instance, an automatic ping may be set up by a user to be executed based on a triggering condition associated with a new application, resource, or device being detected or provisioned in a network such that the connectivity of this new application, resource, or device is automatically checked using ping commands involving that application, resource, or device when it appears in the network. As another example, periodic pings may be set up between (e.g., randomly chosen or specified) network devices to occur regularly at specified times or intervals (e.g., similar to a cron job). These pings may also be scheduled between specific network devices or randomly selected network devices for certain days or times.

Embodiments may be utilized in a similar manner in association with traceroutes. Specifically, embodiment may be used to provide a trace map at a central network management system, where all the traceroutes, pings, or various TTLs may be highlighted on a (e.g., graphical) presentation of the topology of the network. These traceroute may be used to determine or check the health of network devices by highlighting, on a topology map or otherwise, if a network diagnostic packet was lost at a node (e.g., other than a node where a TTL was exceeded) and to diagnose or determine congested or higher latency paths to determine and avert issues on the network before they occur.

Similarly, a traceroute mesh may be used to perform traceroutes from one device and another device, from one device to many other network devices or between many network devices and many other network devices. The results of these traceroute commands may be displayed on a trace map as discussed. Such a traceroute mesh capability may be leveraged for various scenarios. For example, to obtain a sampling of network health, a random list of devices (e.g., IP address) may be selected in the network and traceroutes issued between them.

Embodiments may also be used to set up automatic traceroutes between specified sets of network devices (or set to use randomly selected network devices) where those automatic traceroutes may be triggered by various network events such as network errors, congestion, higher packet latency, packet loss, link failures, etc. between the affected nodes or from a node to an application, etc. Similarly, to the capabilities with respect to pings discussed above, a user may establish conditions for such automatic traceroutes through an interface at a central network management system and be altered when such automatic traceroutes are triggered or alerted to the results of such traceroutes. These conditions or triggers for triggering these pings or traceroutes can be based on a specified set of conditions including such as custom events or events associated with the network or particular devices in the network, including new applications, resources or devices being added to the network, or altered. As another example, periodic traceroutes may be set up such as a traceroute between randomly chosen or specified) network devices that are set up to occur regularly at specified times or intervals.

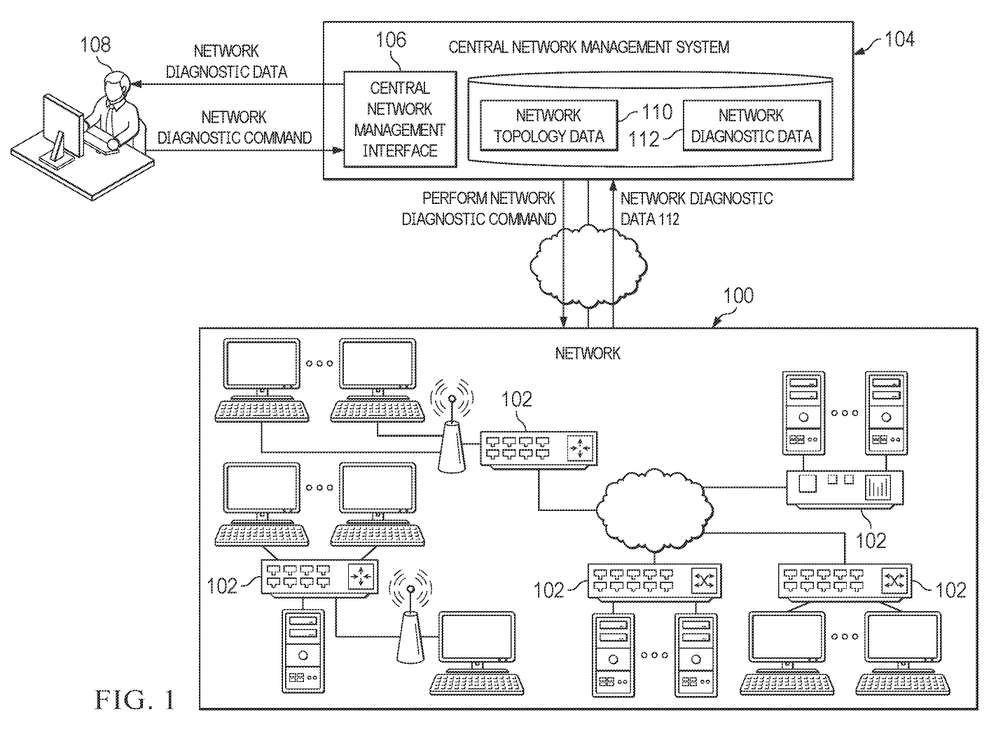

FIG. 1 depicts a network including an embodiment of a central network management system and network devices adapted to cooperate to provide for the execution of network diagnostic commands, and access to data pertinent to the execution of those commands, through the central network management system. Here, network 100 may include a set of network devices 102 that implement network 100. These network devices 102 include network infrastructure devices that implement the functionality of network 100 by routing, forwarding or otherwise processing network traffic (referred to herein without loss of generality as packets). Such network devices 102 can include switches, routers, firewalls, hubs, modems, access points, bridges, repeaters, gateways, load balancers, etc.

Central network management system 104 may be a management system adapted to provide network management functionality in association with network devices 102 and network 100. Central network management system 104 may be implemented on a cloud based, or otherwise distributed, computing platform, or may be implemented on one or more computing devices included in, or connected to, network 100. Central network management system 104 may provide a unified management plane across the network 100 including providing functionality to allow real-time network visibility or the provisioning of analytics to monitor the state of devices 102 in network 100. Central network management system 104 may thus obtain or determine certain data during operation, including network topology data 110 representing the topology (e.g., paths or interconnects) of network 100.

Central network management system 104 may also provide central network management interface 106. This interface 106 can allow a user 108 to specify a network diagnostic command (e.g., collectively used to refer to a particular command available through an operating system of a network device 102 such as a ping or a traceroute command, or an access to a functionality, tool, or application, available on a network device 102 such as Iperf, Ethxmit, or PBT related functionality). Central network management interface 106 may also provide the ability for user 108 to specify a source network device 102 or a destination network device 102 for that network diagnostic command (e.g., as an IP address or using other identifiers associated with a source network device 102 or destination network device 102), along with any other command data to be used in association with the specified network diagnostic command, such as packet or device characteristics to utilize with the specified network diagnostic command.

Based on the specified diagnostic command (e.g., and the associated source or destination), the central network management system 104 can access the (e.g., specified) source network device 102 associated with the network diagnostic command, such as through an eAPI or SSH, to execute the network diagnostic command on the source network device 102. Network devices 102 in network 100 may be adapted to provide network diagnostic data 112 associated with the execution of the network diagnostic command in network 100. This network diagnostic data 112 may include data on packets used to implement the network diagnostic command (e.g., including copies, or portions, of the packets themselves in some embodiments) along with other network diagnostic data obtained as a result of the execution of the network diagnostic command (e.g., the data resulting from the execution of the network diagnostic command). In particular, network diagnostic data on the execution of the network diagnostic command may be provided from multiple (e.g., each) network devices 102 in the path between the source network device 102 accessed by central network management system 104 to perform the network diagnostic command, and the destination network device 102 (e.g., specified for the network diagnostic command).

Central network management system 104 thus receives network diagnostic data 112 from one or more of the network devices 102 in association with the execution of the network diagnostic command. Central network management system 104 may correlate the received network diagnostic data 112 associated with the network diagnostic command at the central network management system 104. Central network management system 104 can present network diagnostic data associated with the network diagnostic command initiated at the central network management system 104 to the user 108 who initiated that network diagnostic command though central network management interface 106. Moreover, central network management system 104 may associate network diagnostic data 112 with network topology data 110 obtained, or determined, on network 100 such as network topology data or the like. This network diagnostic data presented to a user may thus include the data returned by the network diagnostic command, data resulting from an analysis of the network diagnostic data returned by the network devices 102 used to implement the network diagnostic command, including one or more paths between the source or destination, bottlenecks or other impediments to traffic identified through such an analysis, or a visual mapping of the topology of the network 100 associated with implementation of the network diagnostic command (e.g., a visual representation of how packets associated with the network diagnostic packet traversed the network).

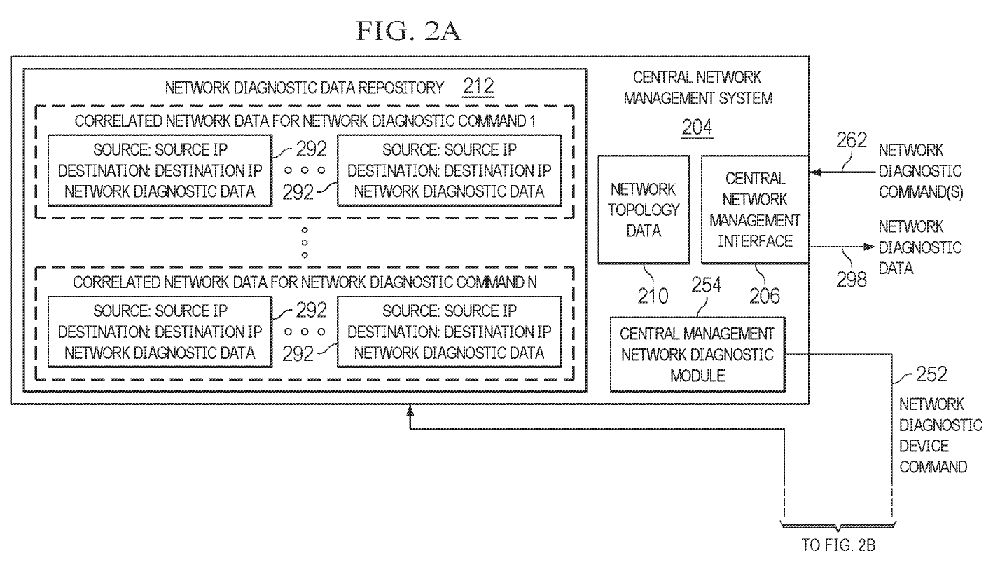

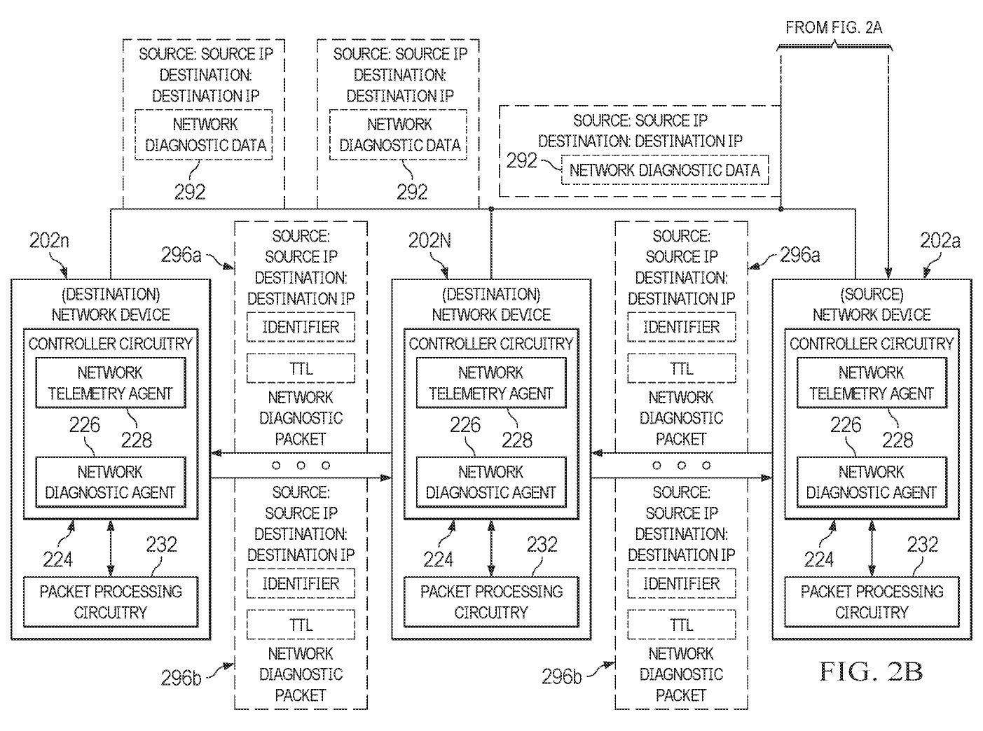

FIG. 2 depicts one embodiment of a central network management system and network devices adapted to cooperate to provide for the execution of network diagnostic commands, and access to data pertinent to the execution of those commands through the central network management system. Here, network devices 202 in a network may include packet processing circuitry 232 that may be used in forwarding or routing packets by the network device 202, and may be used in performing other suitable actions on incoming packets (e.g., a data plane). Packet processing circuitry 232 may be implemented using one or more integrated circuits such as dedicated high-speed switch circuits (e.g., ASICs) or memories and may serve as a (e.g., hardware) data path.

Control circuitry 224 may include processing and memory circuitry (e.g., one or more processing units, microprocessors, memory chips, non-transitory computer-readable storage media, and other control circuitry) for storing and running control software (e.g., a control plane). Control circuitry 224 may store and run software that may be used to implement a control path, may be used to support the operation of packet processing circuitry 232, and may store packet forwarding information. Thus, a network diagnostic agent 226 may execute on control circuitry 224 of network device 202 along with a network telemetry agent 228. The network telemetry agent 228 may be adapted to provide data (e.g., network diagnostic data 292 or the like) to a central network management system 204. This network diagnostic data 292 may include portions (e.g., a subset or the entirety of) of a packet received at the network device. Examples of implementations that may be utilized to provide such network telemetry agents are discussed, for example, in U.S. Patent No. 11,792,092 to Rangarajan et al, issued on October 18, 2023, and hereby incorporated by reference in its entirety for all purposes.

To provide packets to control circuitry 224, packet processing circuitry 232 may include a matching engine configured to selectively identify packets to be sampled using a matching table (sometimes referred to herein as a sampling table or sampling entries in the matching table, when the corresponding entries are used to sample packets for telemetry or for other functions). As an illustrative example, packet processing circuitry 232 may include a TCAM-based matching engine having TCAM circuitry for storing the matching table (e.g., a TCAM table where an array of memory elements in the TCAM circuitry store entries in the matching table).

In particular, the matching table may include entries that have corresponding values associated with respective data fields. These table entry values may be compared to values at the same respective packet data fields (e.g., data fields that the table entries match on). In such a manner, the two corresponding values (e.g., values stored at the table entries and the values in the packet fields) may be compared to determine whether a match exists between that entry and the packet, in which case the packet processing circuitry 232 may take the corresponding action (e.g., provide packet data on the packet to the control circuitry 224).

Specifically, packet processing circuitry 232 may forward a sampled or encapsulated version of a packet (e.g., a network diagnostic packet) to control circuitry 224, where it may be provided to network diagnostic agent 226. In particular, this forwarded packet may also include telemetry information. As examples, in addition to including one or more fields (e.g., all of the fields of packet) copied from the received packet (e.g., identifying a source network device or destination network device for the packet), this data may also include forwarding information such as an ingress interface information, egress interface information, temporal information such as ingress time, egress time, identifier information for network device 202, policy information, or other suitable annotation information for telemetry.

Network diagnostic agent 226 can access the sampled version of the packet received from packet processing circuitry 232 and may send network diagnostic data 292 to central network management system 204 based on this sampled packet, where this network diagnostic data 292 may include the packet itself, or a portion thereof, along with additional or modified data. In particular, network diagnostic agent 226 may send network diagnostic data 292 to central network management system 204 using network telemetry agent 228.

Central network management system 204 may be a management system adapted to provide network management functionality in association with network devices 202 or a network, including providing a unified management plane across the network to, for example, provide real-time network visibility and analytics to monitor the state of devices 202 in the network. Central network management system 204 may thus obtain or determine certain data during operation, including network topology data 210 representing the topology (e.g., paths or interconnects) of the network under management.

For example, central network management system 204 may gather information about the topology of a network using Link Layer Discovery Protocol (LLDP) packets from network devices 202 to gather information about and identify the topology of the network. If desired, a link-state routing protocol such as Intermediate System to Intermediate System (IS-IS) protocol or Open Shortest Path First (OSPF) protocol may be used to gather link state information about neighboring devices. Such data can be received, for example, using the Border Gateway Protocol (BGP) routing protocol (e.g., using BGP-LS). As another example, central network management system 204 may send LLDP probe packets or other packets through the network to identify the topology of the network.

Central network management system 204 may also provide central network management interface 206. This interface 206 can allow a user to specify a network diagnostic command 262 (e.g., collectively used to refer to a particular command available through an operating system of a network device 202 such as a ping or a traceroute command, or functionality, tools or applications available on a network device 202 such as Iperf, Ethxmit or PBT functionality). Central network management interface 206 may also provide the ability for a user to specify a source network device 202a or a destination network device 202n for that specified network diagnostic command 262 (e.g., as IP addresses or using other identifiers associated with a source network device 202a or destination network device 202n), along with any other network diagnostic data to be used in association with the specified network diagnostic command 262, such as packet or device characteristics to utilize with the specified network diagnostic command 262. Users may also specify other command data, such as how many times they wish to execute the network diagnostic command (e.g., in the case where there may be multiple paths between a source network device 202a and destination network device 202n and they wish to obtain data on such multiple paths, etc.).

Based on the specified network diagnostic command 262 (e.g., and the associated source or destination network device 202), network diagnostic module 254 at the central network management system 204 can access the network diagnostic agent 226 at the (e.g., specified) source network device 202a, such as through an eAPI or SSH, to execute one or more corresponding network device diagnostic commands 252 (e.g. a specified ping or traceroute command or the tool or functionality available on a network device 202), and may execute this diagnostic command 252 one or more times on the specified source network device 202a (e.g., based on a number of execution time specified by a user, a number of times configured at the network diagnostic module 254, etc.)

In one embodiment, when network device diagnostic command 252 is initiated on source network device 202a, network diagnostic agent 226 (e.g., on the source network device 202a) creates a mirror session from the data plane of the network device 202a (e.g., implemented using packet processing circuitry 232) to the control plane of the network device 202 (e.g., implemented utilizing controller circuitry 224). Accordingly, when a network diagnostic agent 226 executes network device diagnostic command 252 at the network device 202 (e.g. a ping or a traceroute command) that was initiated by a central network management system 204, the network diagnostic agent 226 may establish a mirrored session for the session used to execute that network diagnostic command.

Thus, data associated with the execution of that network device diagnostic command 252 may be mirrored to the control plane of the network device 202 and, more specifically, mirrored to the network diagnostic agent 226 at the source network device 202a executing the network device diagnostic command 252. As this data (e.g., network diagnostic packets such as ICMP packets) is received by the network diagnostic agent 226 at the network device 202 through the mirrored session, network diagnostic data 292 may be provided to the network diagnostic module 254 at central network management system 204 through the network telemetry agent 228 at the network device. Network diagnostic module 254 at central network management system 204 can store received network diagnostic data 292 at the central network management system 204.

In some embodiments, network diagnostic data 292 may be reported to network diagnostic module 254 at central network management system 204 from network diagnostic agents 226 on all, or a subset of, network devices 202 involved in the execution of the network device diagnostic command 252 (e.g., along a path in the network between source network device and a destination network device for a network diagnostic command). Specifically, when network device diagnostic command 252 is initiated on source network device 202a, network diagnostic agent 226 at the source network device 202a may mark a network diagnostic packet 296a sent for implementing the network device diagnostic command 252 (e.g., an ICMP Echo Request packet), such as including a particular identifier in that network diagnostic packet 296a. This identifier may be a central network management system initiated identifier indicating the network diagnostic command with which the network diagnostic packet 296a is associated was initiated from central network management system 204 (e.g., as opposed to the network diagnostic command being initiated by a user through the CLI of the source network device).

As this marked network diagnostic packet 296a traverses the network each (or a subset) of the network devices 202 through which the packet 296a passes that includes an installed network diagnostic agent 226 may determine that this (e.g., marked) network diagnostic packet 296a is associated with a network diagnostic command initiated by central network management system 204 and send network diagnostic data 292 (e.g., a copy of the packet or a portion of the packet 296, or other network diagnostic data) to central network management system 204 using network telemetry agent 228 on that network device 202. In particular, packet processing circuitry 232 of network device 202 may determine that the identifier is included in network diagnostic packet 296a as that packet 296 is processed in the data plane of the network device 202 and may forward a sampled or encapsulated version of this packet 296 to control circuitry 224, where it may be provided to network diagnostic agent 226. Network diagnostic agent 226 can then determine that this forwarded packet 296 includes that (central network management system) identifier, determine network diagnostic data 292 associated with that network diagnostic packet 296a, and provide that network diagnostic data 292 to network telemetry agent 228 for sending to network diagnostic module 254 at central network management system 204. Network diagnostic module 254 can store received network diagnostic data 292 in network diagnostic data repository 212 at the central network management system 204.

Additionally, any response network diagnostic packet 296b (e.g., ICMP Echo Reply) sent from the destination network device 202n (e.g., specified in a network diagnostic command) may likewise be marked with the same identifier (e.g., central network management system initiated identifier). Thus, as this response network diagnostic packet 296b traverses the network on a path back to the source network device 202a, each of those network devices 202 with an installed network diagnostic agent 226 may also determine that this response network diagnostic packet 296b is associated with a network device diagnostic command 252 initiated by central network management system 204, and send network diagnostic data 292 (e.g., a copy of response network diagnostic packet 296b or a portion of the packet 296b, etc.) to the central network management system 204 using the network telemetry agent 228 on that network device 202.

In some embodiments, to allow network devices 202 along the path (e.g., between the source network device and the destination network device) to implement the network diagnostic command 252 to send associated network diagnostic data 292 to the central network management system 204, certain options may be utilized by network diagnostic agent 226 when initiating the network device diagnostic command 252 at source network device 202a. These options may be used, for example, in conjunction with, or alternatively to, marking a network diagnostic packet 296 with an identifier. For example, when initiating a ping command a network diagnostic agent 226 at source network device 202a may initiate the ping command to the specified destination network device 202n using a record route option for the ping command. Not only does the use of such an option cause network device 202 along the path between the source device 202a and the destination device 202n to add their IP address to the network diagnostic packet 296 (e.g., ICMP packet’s) options field, but may additionally cause that network diagnostic packet 296 to be processed in the control plane at each network device 202. In these embodiments, network diagnostic agent 226 may be adapted to detect network diagnostic packets 296 (e.g., ICMP packets) being processed in the control plane of the network device 202 on which it is executing and provide network diagnostic data 292 on this network diagnostic packet 296 (e.g., a copy of network diagnostic packet 296 or a portion of the packet, etc.) to the network telemetry agent 228 present on the network device 202 to send to the central network management system 204.

In one embodiment, the implementation of network device diagnostic command 252 may be utilized to cause network devices 202 along the path between the source device 202a and the destination device 202n to send network diagnostic data 292 to central network management system 204. For example, a traceroute command works by utilizing the TTL field in IP packets to map a path between source network device 202a and destination network device 202n. Specifically, the source network device 202a sends out a set of network packets with increasing values in the TTL field. As each network diagnostic packet 296 traverses the hops along the path to the destination network device 202n, each network device 202 along the path decrements the TTL field. When the TTL value of the network diagnostic packet 296 reaches zero (e.g., after decrementing the TTL value), the network device 202 discards the packet and sends an ICMP "Time Exceeded" message back to the source network device 202a. Thus, in these embodiments, the network diagnostic agent 226 may be adapted to detect network diagnostic packets 296 being processed by network device 202 on which it is installed that have a TTL value of zero after decrementing the TTL value and provide network diagnostic data 292 on this network diagnostic packet 296 (e.g., a copy of network diagnostic packet 296 or a portion of the packet, etc.) to the network telemetry agent 228 present on the network device 202 to send to the central network management system 204.

In certain embodiments, network device diagnostic command 252 may include commands related to functionality, tools or commands for defining and sending custom packets from a source network device 202a (e.g. using a custom definition for one or more characteristics of a packet). Such functionality may be offered in association with the operating system on the network device. For example, the EOS™ network operating system from Arista™ may include tools called Iperf and Ethxmit allowing traffic to be generated from a source to a particular destination network device according to a number of defined characteristics. As another example, the EOS™ network operating system may provide functionality to allow sampled flow tracking. Portions of this sampled flow tracking are referred to as PBT as discussed.

In these embodiments, central network management interface 206 may provide an interface at central network management system 204 that allows a user to specify (e.g., identify) this network diagnostic functionality and a source destination network device 202a and destination network device 202n in the network. The central network management interface 206 may also allow a user to define one or more packet or device characteristics or other command specifics such as a number of time to repeat the command, that a record route option is to be used, etc.

Based on the diagnostic functionality specified by the user through the central network management interface 206 of the central network management system 204, network diagnostic module 254 at the central network management system 204 can access network diagnostic agent 226 on the source network device 202a (e.g., through an SSH), to execute one or more network device diagnostic commands 252 to implement the functionality according to the packet or device characteristics as specified by the user through the central network management interface 206.

The network diagnostic agent 226 on the source network device 202a can then execute received network device diagnostic commands 252 at the source network device 202a. Network diagnostic data 292 associated with the execution of these network commands 252 can then be reported to the central network management system 204 from one or more network devices 202 on the network involved with execution of those network commands 252 using the network diagnostic agents 226 and network telemetry agents 228 on those network devices 202. For example, a mirror session may be created by the network diagnostic agent 226 on the source network device 202a when executing the network commands 252 received from the central network management system 204 such that data associated with the execution of the network commands 252 may be mirrored to the network diagnostic agent 226 at the source device 202a. Network diagnostic agent 226 can use this mirrored data to provide network diagnostic data 292 (e.g., data resulting from the execution of network command 252) to the network telemetry agent 228 present on the network device 202 to send to the central network management system 204.

In some cases, when network device diagnostic commands 252 are executed or otherwise carried out by the network diagnostic agent 226 at the source device 202a, network diagnostic module 254 may specify (e.g., as a packet characteristics) that a particular identifier (e.g., an identifier associated with central network management system 204) is included in the packets. The initiation of the network device diagnostic commands 252 by the central network management system 204 thus causes diagnostic packets 296 to be marked as they traverse the network. Accordingly, as these marked network diagnostic packets 296 traverse the network, each of the network devices 202 with an installed network diagnostic agent 226 may determine that this packet 296 includes that identifier, determine network diagnostic data 292 associated with that network diagnostic packet 296, and provide that network diagnostic data 292 to network telemetry agent 228 for sending to network diagnostic module 254 at central network management system 204.

Accordingly, in various embodiments the central network management system receives network diagnostic data 292 (e.g., copies of packets 296, packet data from packets 296, data resulting from the execution of network device diagnostic command 252, etc.) from the network telemetry agent 228 on one or more of the network devices 202 in the network involved with the execution of network device diagnostic command 252. As central network management system 204 receives network diagnostic data 292, central network management system 204 may store this network diagnostic data 292 in network diagnostic data repository 212.

Central network management system 204 can thus correlate received network diagnostic data 292 associated with the network device diagnostic command 252 (e.g., from different network devices 202, from the same network device 202 at different times, etc.). In one embodiment, for example, network diagnostic data 292 received from network devices 202 may be correlated with a network device diagnostic command 252 based on the presence of the same specified source and destination network device (e.g., IP address) in the network diagnostic data 292 (e.g., including a copy of, or information from, a network diagnostic packet 296) received from each of the network devices 202.

Other data may also be used to correlate, or otherwise analyze, network diagnostic data 292 received from network devices 202. Such data may include an identifier (e.g., IP address) of the network device 202, network telemetry agent 228 or network diagnostic agent 226 from which the network diagnostic data 292 was received, a timestamp associated with the network diagnostic data 292, or other data. For example, central network management system 204 may track network device diagnostic commands 252 issued at the central network management system 204 and may correlate received network diagnostic data 292 with these issued network device diagnostic commands 252 instituted at the central network management system 204.

Thus, as the central network management system 204 may have network diagnostic data 292 from (e.g., all or a subset of) network devices 202 comprising the hops that packets associated with a network device diagnostic command 252 took through the network, the central network management system 204 may present network diagnostic data 298 on the network diagnostic command 262 initiated at the central network management system 204 to the user who initiated that network diagnostic command 262. This presented network diagnostic data 298 may include network diagnostic data 292 returned by the network device diagnostic command 252, data resulting from an analysis of the network diagnostic data 292 returned by the network devices 202 used to implement the network device diagnostic commands 252, including network topology data on one or more paths between the source network device 202a or destination network device 202n (e.g., as determined from the network diagnostic data 292 from the network devices 202 or network topology data 210 on the network), bottlenecks or other impediments to traffic identified through such an analysis, or a visual mapping of the topology of the network associated with implementation of the network diagnostic command (e.g., a visual representation of how the network diagnostic packet traversed the network). Such a visual mapping can be determined, for example, by mapping the source IP and destination IP addresses of the network diagnostic data 292 to network topology data 210 at central network management system 204.

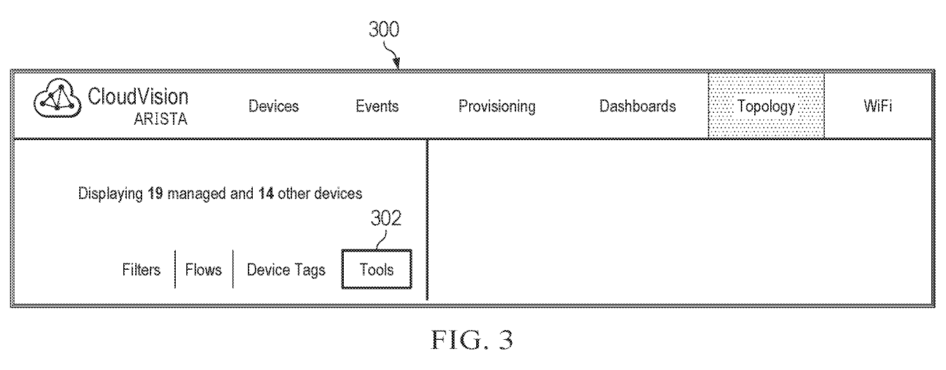

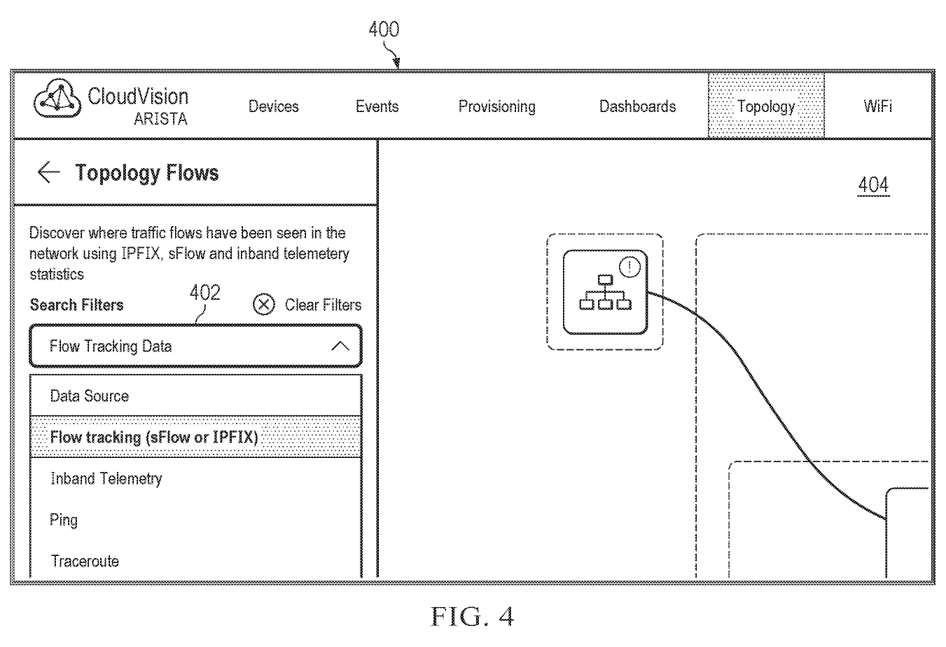

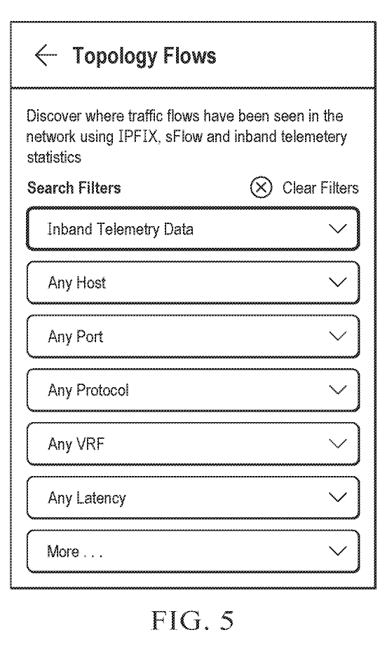

Looking now at FIGS. 3-5, embodiments of interfaces that may be presented by a central network management system to allow a user to initiate or specify a network diagnostic command are presented. For example, in FIG. 3, area 302 of interface 300 may provide an option named “Debug” or “Troubleshoot” or “Tools” whereby interacting with that option (e.g., clicking on it) a user may access an interface to specify a network diagnostic command to be executed at a source network device. Similarly, in FIG. 4, a drop down menu 402 may be provided in an interface 400 such that a “ping” or “traceroute” option may be offered in a flow tracking interface to allow a user to specify a particular network diagnostic command and associated source or destination network device. FIG. 5 depicts an interface that may be used to provide command data for the network diagnostic command (e.g., additional options that can be passed with ping and traceroute commands). Here, as network diagnostic data is returned from network devices in association with the execution of the network diagnostic command, network topology data and network diagnostic data may be presented in area 404 of FIG. 4 to show the network devices involved with the execution of the network diagnostic command, the topology of those network devices, or other data. For example, the topology of a network may be depicted with the path taken to perform the network diagnostic command highlighted or otherwise indicated on the depiction of the network topology.

It will be understood that while specific embodiments have been presented herein, these embodiments are merely illustrative, and not restrictive. Rather, the description is intended to describe illustrative embodiments, features, and functions in order to provide an understanding of the embodiments without limiting the disclosure to any particularly described embodiment, feature, or function, including any such embodiment, feature, or function described. While specific embodiments of, and examples for, the embodiments are described herein for illustrative purposes only, various equivalent modifications are possible within the spirit and scope of the invention, as those skilled in the relevant art will recognize and appreciate.

As indicated, these modifications may be made in light of the foregoing description of illustrated embodiments and are to be included within the spirit and scope of the disclosure. Thus, while particular embodiments are described, a latitude of modification, various changes and substitutions are intended in the foregoing disclosures, and it will be appreciated that in some instances some features of embodiments of the invention will be employed without a corresponding use of other features, and features described with respect to one embodiment may be combined with features of other embodiments without departing from the scope and spirit of the disclosure as set forth.

What is claimed is:

1. A method, comprising
receiving, through a network management interface of a central network management system, a specification of a network diagnostic command available on a command line interface of a network device and network diagnostic command data specifying a source network device in a network;
executing, by the central network management system, the specified network diagnostic command on the specified source network device according to the network diagnostic command data;
at the central network management system, receiving first network diagnostic data resulting from the execution of the network diagnostic command from the source network device, wherein the first network diagnostic data comprises data on the execution of the specified source network command between devices or resources in the network; and
presenting, at the central network management system, second network diagnostic data from the execution of the network diagnostic command on the source network device, wherein the second network diagnostic data is determined from the first network diagnostic data.

2. The method of claim 1, wherein the central network management establishes a secure shell with the source network device, or uses an embedded Application Programming Interface (eAPI), to execute the network diagnostic command.

3. The method of claim 1, wherein the network diagnostic command data includes a destination network device, and the method further comprises receiving third network diagnostic data from at least one network device on a path in the network between the source network device and the destination network device.

4. The method of claim 3, further comprising:
causing to be marked, at the source network device, a network diagnostic packet for execution of the network diagnostic command with a central network management system identifier.

5. The method of claim 4, further comprising:
determining, at the at least one network device on the path, that the network diagnostic packet includes the central network management system identifier; and
in response to the determination that the network diagnostic packet includes the central network management system identifier, causing the third network diagnostic data to be sent to the central network management system from the at least one network device.

6. The method of claim 3, further comprising: correlating, at the central network management system, the first network diagnostic data with the third network diagnostic data to determine the second network diagnostic data.

7. The method of claim 6, wherein the first network diagnostic data and the third network diagnostic data comprise the network diagnostic packet.

8. The method of claim 7, wherein the first network diagnostic data and the third network diagnostic data are correlated at the central network management system based on the source network device and the destination network device associated with the network diagnostic packet.

9. The method of claim 4, wherein the central network management system identifier is adapted to cause the network diagnostic packet to be provided to a network diagnostic agent in a control plane of the at least one network device.

10. The method of claim 3, wherein the network diagnostic command is a ping or traceroute command.

11. The method of claim 10, wherein the network diagnostic command is executed with an option on the network diagnostic command set, the option adapted to cause the network diagnostic packet to be processed in a control plane of the at least one network device on the path in the network between the source network device and the destination network device.

12. The method of claim 11, wherein:
the network diagnostic packet is identified as being associated with the central network management system in the control plane of the at least one network device; and
third network diagnostic data is sent to the central network management system from the at least one network device in response to identifying the network diagnostic packet in the control plane of the at least one network device.

13. The method of claim 3, wherein the network diagnostic command is executed multiple times, and the at least one network device comprises network devices in multiple paths of the network between the source network device and destination network device.

14. A system adapted for execution of network diagnostic commands in association with a central network management system, comprising:
a central network management system; and
a set of network devices in a network managed by the central network management system, wherein each of the set of network devices comprises a processor and a non-transitory computer readable medium including instructions executable on the processor to implement a network diagnostic agent adapted to:
identify a network diagnostic packet received at the network device, wherein the network diagnostic packet is associated with a network diagnostic command executed between a source network device by the central network management system and a specified destination network device;
generate network diagnostic data based on the identified network diagnostic packet; and
send the generated network diagnostic data to the central network management system.

15. The system of claim 14, wherein the network diagnostic data comprises the identified network diagnostic packet.

16. The system of claim 15, wherein the network diagnostic packet is an Internet Control Message Protocol (ICMP) packet.

17. The system of claim 15, wherein the network diagnostic agent is adapted to identify the network diagnostic packet by determining the network diagnostic packet is marked with a central network management system identifier.

18. The system of claim 15, wherein the central network management system is adapted to:
receive first network data from a first network device on a path in the network between the source network device and the destination network device;
receive second network data from a second network device on the path in the network between the source network device and the destination network device;
correlate the first network diagnostic data with the second network diagnostic data based on the source network device and the destination network device to determine third network diagnostic data; and
present the third network diagnostic data to a user in association with the network diagnostic command.

19. The system of claim 18, wherein the third network diagnostic data includes network topology data for the network associated with the path in the network between the source network device and the destination network device.

20. A non-transitory computer readable medium, comprising instructions executable on a processor for:
receiving, at a central network management system, a specification of a network diagnostic command available on a command line interface of a network device, a source network device in a network and a destination network device in the network;
executing, by the central network management system, the specified network diagnostic command on the specified source network device;
receiving, at the central network management system, network diagnostic data from a set of network devices on a path in the network between the source network device and the destination network device;
correlating, at the central network management system, the received network diagnostic data based on the source network device and the destination network device to determine network topology data associated with the path; and
presenting, by the central network management system, the determined network topology data associated with the path in association with the network diagnostic command.
